(19) United States
(12) Patent Application Publication
(10) Pub. No.: US 2004/0074402 A1
(43) Pub. Date: Apr. 22, 2004

(54) Oil extractor and related methods

(75) Inventor: Kalpeshkumar Chandulal Gajjar, Visnagar (IN)

Correspondence Address: TESTA, HURWITZ & THIBEAULT, LLP, HIGH STREET TOWER, 125 HIGH STREET, BOSTON, MA, 02110, US

(73) Assignee: Society for Research and Initiatives (SRISTI), Ahmedabad (IN)

(21) Appl. No.: 10/277,859

(22) Filed: Oct. 22, 2002

(51) Int. Cl. A23N 1/00

(52) U.S. Cl. 99/495

(57) ABSTRACT

Methods and devices for extracting oil from oil seeds, which further include the extraction of an oil seed cake. In a preferred embodiment the oil extractor apparatus includes a steam chamber, a worm drive housing in communication with the steam chamber, a worm drive contained within the worm drive housing, where the worm drive has a first end and a second end, a driver in communication with the worm drive, and an oil seed cake thickness adjuster in communication with the second end of the worm drive, wherein the thickness of an oil seed cake is adjusted during operation of the oil extractor. Another preferred embodiment further includes a power transmission assembly comprised of a plurality of planetary gears between the driver and the worm drive.

### TECHNICAL FIELD

This invention relates to oil extractors and more particularly, to oil seed oil extractor units.

### BACKGROUND OF THE INVENTION

Oil-bearing seeds are a vital part of the world's ecosystem. These seeds provide nutritional, agricultural, industrial, medical, and scientific benefits, to name a few. In many developing countries various types of oil seeds account for a large amount of the food supply. Besides utilizing oil seeds whole, many uses for oil seeds are derived from both the seed oil that can be extracted from oil seeds and from the seed cake, or solid residue of the oil seed after the oil is extracted.

In order to meet the demand for oil seed products, the production and processing of oil seeds is an enormous and competitive industry that relies on heavy industrial-grade machines. Oil extracting equipment is used to separate the oil from the oil seed cake, and has traditionally involved the integration of separate large pieces of machinery. These processing configurations require operators for each piece of machinery, as well as laborers to perform maintenance on the multitudes of mechanical parts. Eventually integrated oil extracting units were introduced which help to reduce the operational and maintenance requirements, and thus costs. However, integrated machines are still inefficient largely due to the most common belt-and-pulley based drive systems. The belt-and-pulley drive systems not only transfer power inefficiently, but due to excessive vibration, strong concrete foundations are required to support them. Additionally, those systems are very expensive to operate due to the maintenance programs necessary to remedy and prevent the toll excessive vibration takes on the equipment.

Some transmission-based oil extractors eliminate the need for concrete foundations, reduce the vibration issues, operate more efficiently than belt-and-pulley systems, and require fewer operators. However, high energy requirements are still problematic, and oil seed product is often wasted due to ineffective control of the quality of the output. Oil extractors are difficult to clean, particularly in the crushing region, thereby adversely affecting production quality. Most importantly, however, the crushing pressure (the pressure at which the oil seeds are crushed) is a crucial factor in determining both the quality of the oil and the quality of the oil seed cake produced. Different seeds require different compression ratios for crushing, and different weather conditions change the texture, characteristics, and crushing requirements of the oil seeds. Crushing pressures often need to be adjusted during the course of operation to prevent under-crushing or, especially, over-crushing. Varying the thickness of the oil seed cake is a key to fine-tuning the crushing pressure, thereby improving quality of both the oil and the oil seed cake. However, switching the machine on and off to vary the thickness results in increased transmission losses, increased costs to stop and restart, increased wear-and-tear on the equipment, and additional labor to effect the process.

### SUMMARY OF THE INVENTION

The invention relates to an oil extractor used for extracting oil from oil seeds. The oil extractor includes a steam chamber, a worm drive housing in communication with the steam chamber, and a worm drive contained within the worm drive housing. The worm drive has a first end and a second end. A driver is in communication with the worm drive. In one embodiment the steam chamber is not included as part of the oil extractor.

In one embodiment the oil extractor further includes an oil seed cake thickness adjuster in communication with the second end of the worm drive. The thickness of an oil seed cake can be adjusted during operation of the oil extractor. Besides the extraction of oil, an oil seed cake is also extracted, where the oil seed cake is comprised of the solid matter remnants of the oil seeds after the oil is removed.

The present invention also describes an apparatus for adjusting the thickness of the oil seed cake. The oil seed cake thickness adjuster includes a cone that has a first end and a second end that surrounds the worm drive at the second end of the worm drive. A jack is located at the second end of the cone. The jack displaces the cone to a clearance that facilitates a desired thickness for the oil seed cake.

In another embodiment the oil extractor includes a retainer that is in communication with the steam chamber. The retainer is used to retain oil seeds before the oil seeds enter the steam chamber. In another embodiment the retainer includes a transporter to move oil seeds through the retainer and the steam chamber. More advantages are provided when the transporter is coupled with a motor-driven steam chamber shaft that comprises a plurality of rotating members that push oil seeds through the steam chamber. Yet more advantages are provided when the transporter also comprises a plurality of members to push oil seeds along the steam chamber.

In another embodiment the oil extractor includes a variable pitch worm drive. The pitch can be varied from the first end to the second end of the worm drive. In another embodiment the pitch of the worm drive can be changed for each operation of the oil extractor. Further advantages are obtained when the pitch of the worm drive decreases from the first end to the second end of the worm drive.

In another embodiment of the invention the oil extractor is driven by a power transmission driver.

In another embodiment the oil extractor further comprises a rotatably mounted chute that is located between the steam chamber and the worm drive. The chute facilitates movement of oil seeds from the retainer or the steam chamber to the worm drive.

In another embodiment the invention relates to an oil extractor that includes a means for steaming oil seeds, a means for crushing the oil seeds in communication with the means for steaming oils seeds, and a means for adjusting the thickness of oil seed cake that is in communication with the means for crushing the oil seeds.

The present invention also provides a method for extracting oil from oil seeds. The method includes providing a plurality of oil seeds, crushing the oil seeds into an oil seed cake, and varying the thickness of the oil seed cake during oil extracting. In another embodiment the method for extracting oil from oil seeds further includes the step of steaming the plurality of oil seeds prior to crushing the oil seeds.

The present invention also describes an apparatus for transferring power from a driver to a plurality of worm drives for an oil extractor. The apparatus includes a power transmission assembly which is centered about an interconnected arrangement of directly and rotatably coupled planetary gears. The power transmission assembly of the apparatus further includes a first and a second stage of planetary gear assemblies, each comprised of a fixed ring gear, a planetary carrier, a sun gear, and a plurality of planet gears, where the first and second stage planetary gear assemblies are linked via a transfer gear pinion and a transfer gear wheel.

### BRIEF DESCRIPTION OF THE DRAWINGS

The foregoing and other objects, aspects, and advantages of the invention and the various features thereof may be more fully understood from the following description when read together with the accompanying drawings in which like reference designations generally refer to the same parts throughout the different views and in which the depicted components are not necessarily drawn to scale.

FIG. 1 is a schematic block diagram of an embodiment of an oil extractor, constructed according to the invention;

FIG. 2 is a perspective view of an embodiment of an oil extractor, constructed according to the invention;

FIG. 3 is a cross-sectional view along AA′ of the oil extractor of FIG. 2;

FIG. 4 is a cross-sectional view along AA′ of the oil extractor of FIG. 2 further depicting the oil seed processing path;

FIG. 5 is a cross-sectional view depicting the details of an embodiment of an oil seed cake thickness adjuster, constructed according to the invention;

FIG. 6 is a perspective view of a preferred embodiment of an oil extractor, constructed according to the invention; and

FIG. 7 is a perspective view of a preferred embodiment of a power transmission assembly, constructed according to the invention.

### DESCRIPTION OF AN ILLUSTRATIVE EMBODIMENT

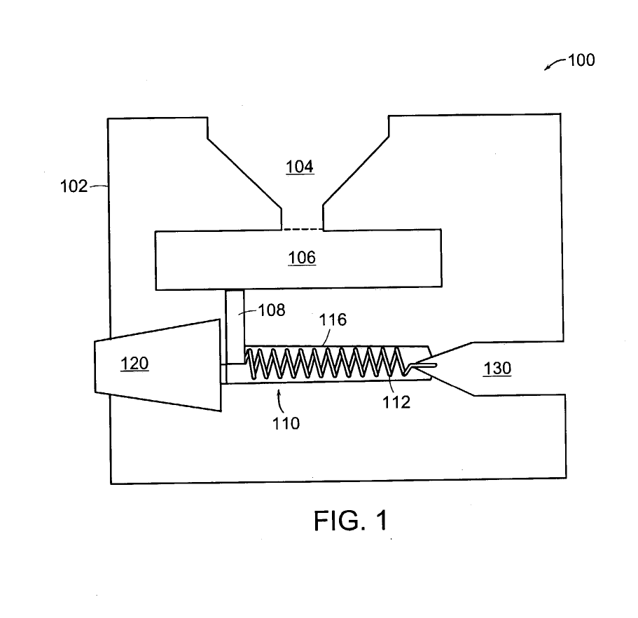

FIG. 1 is a schematic block diagram of an oil extractor, according to an illustrative embodiment of the invention. Referring to this embodiment, oil extractor 100 includes a housing 102. In one embodiment housing 102 contains a retainer, or hopper, 104, a steam chamber 106, a chute 108, a worm drive 110 comprising a worm 112 and a casing 116, a driver 120, and an oil seed cake thickness adjuster 130. In operation, oil seeds are deposited in retainer 104 that serves as a container for the incoming oil seeds. The oil seeds can proceed directly from retainer 104 to worm drive 110. However, as in the embodiment shown, the oil seeds proceed to steam chamber 106 and through chute 108 before they enter worm drive 110. Steam chamber 106 steams the oil seeds to soften them in preparation for oil extraction, making it easier for the oil seeds to be crushed and thus for the oil to be extracted.

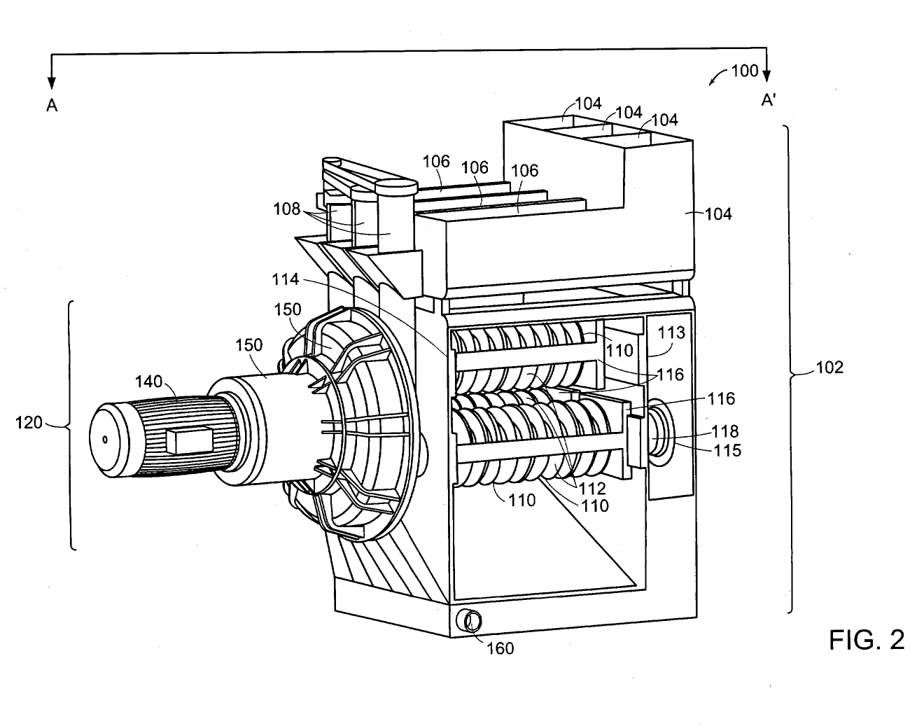

When the oil seeds enter worm drive 110 they are crushed by worm 112 as it rotates inside casing 116. The resulting oil that is extracted from the crushing process is drained from extractor 100, and will be described in more detail below for FIG. 2. The solid seed matter remaining after the oil is drained, known as the oil seed cake, is then extruded from worm drive 110. In a preferred embodiment, the oil seed cake is extracted through an oil seed cake thickness adjuster 130 to vary the thickness of the oil seed cake.

FIG. 2 is a perspective view of an embodiment of an oil extractor 100 constructed according to the invention. In one embodiment retainers 104 and steam chambers 106 adjoin each other and are positioned in the upper portion of housing 102. For added flexibility retainers 104 and steam chambers 106 may be located elsewhere within oil extractor 100. However, the added advantage of the upper housing 102 location for retainers 104 and steam chambers 106 permits chutes 108 to efficiently utilize gravity to assist in positioning the oil seeds at the first end 114 of worm drive 110. FIG. 2 shows a plurality of chutes 108 used to accept the oil seeds from steam chamber 106. Further, FIG. 2 shows a plurality of steam chambers 106 and a plurality of retainers 104 as part of the present invention. Although a plurality of each component allows for a higher volume of seeds to be processed at any given time, there is no required number of steam chambers 106 or retainers 104 that is needed for operation.

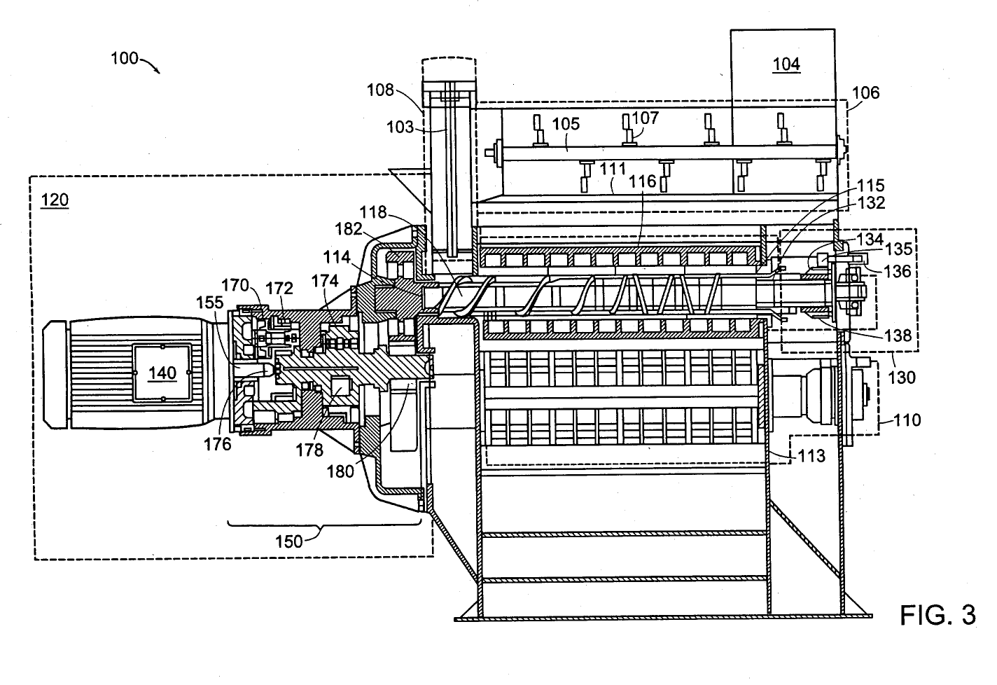

Chutes 108 feed the oil seeds into worm drive housing 113. Worm drive housing 113 is comprised of worm drives 110 which crush the oil seeds using worms 112, which rotate inside casings 116 providing crushing action to the oil seeds. Each worm 112 is comprised of a substantially spiral wound band that is rotated by driver 120. In the embodiment shown, each worm drive 110 is further comprised of a worm 112 disposed upon a worm drive shaft 118 (FIG. 3). Worm drive shaft 118 (FIG. 3) rotates inside casing 116 and is then driven by driver 120, as opposed to worm 112 being driven directly by driver 120. FIG. 2 depicts a plurality of worm drives 110 within worm drive housing 113. The operation of the plurality of worm drives 110 is substantially the same as that of the single worm drive 110 embodiments in that each worm drive 110 operates independently.

Driver 120 may be an engine, a motor, or a comparable type propulsor unit. The driver 120 of FIG. 2 is an electric motor 140 mechanically coupled to worm drive 110 by way of a power transmission assembly 150.

As the oil seeds transit worm drive 110 from first end 114 toward second end 115, the oil seeds are crushed by worm 112 rotating inside casing 116, as the oil seeds are pushed along the length of worm drive housing 113. Oil is extracted from the crushed oil seeds, and the oil is then gravity drained from oil extractor 100 and ultimately through drain 160. The oil collects in casing 116 where it exits casing 116 penetrations and pours into a collection tray (not shown) located below casing 116. The oil is collected in the collection tray (not shown) until the oil reaches the drain line leading to drain 160. Drain 160 penetrates the bottom of the collection tray (not shown) and is drained from housing 102, where it is collected into drums or other similarly suitable containers.

The resulting oil seed cake is extruded from rotating worm 112 and ultimately from worm drive housing 113. In an illustrative embodiment of the invention, an oil seed cake thickness adjuster 130 (FIG. 3) is positioned at second end 115 of worm drive 110. During operation of oil extractor 100, oil seed cake thickness adjuster 130 (FIG. 3) maybe adjusted to vary the thickness of the oil seed cake to a predetermined thickness as the oil seed cake is extruded from worm drive housing 113.

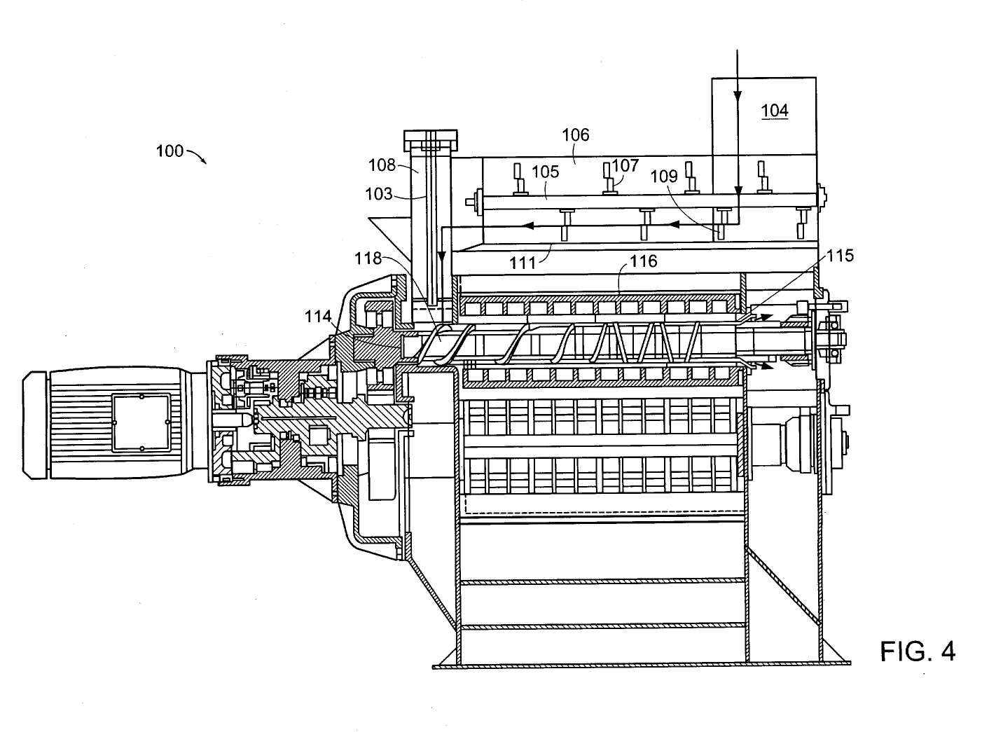

FIG. 3 is a cross-sectional view along AA′ of the oil extractor 100 of FIG. 2, and FIG. 4 further depicts the oil seed processing path. As described generally above, oil extractor 100 is a substantially unitary piece of industrial equipment that takes any of a wide variety of oil seeds in, and extracts oil and an oil seed cake from the oil seeds. More specifically, following the oil seed processing path of FIG. 4 through oil extractor 100, oil seeds begin by being placed into retainer 104. Retainer 104 is shown in FIG. 2 as a plurality of rectangular, structurally-sound containers that serve as holding bins for the oil seeds. An opening in the top of retainer 104 allows for loading the oil seeds. Those skilled in the art will recognize that a wide variety of other shaped bins can be used for retainer 104. Retainer 104 is positioned at the feeding end of steam chamber 106 and is sized suitably to allow the oil seeds to enter steam chamber 106 at a pace commensurate with the capacity of steam chamber 106. The components of the depicted embodiment of oil extractor 100 are rated at a capacity of approximately 18 tons to 28 tons of oil seeds processed per day.

Referring to FIG. 3, retainer 104 is secured at the top of housing 102. Housing 102 is assembled on a main frame using a welded construction or other suitable fastening methods such as bolting, screwing, riveting and the like. Housing 102 provides the structural support for all oil extractor 100 components.

Referring to FIG. 4, after the oil seeds exit retainer 104 they enter steam chamber 106. The entire assembly comprising steam chamber 106 is shown in FIG. 3 outlined in phantom. In actuality, FIG. 2 depicts a plurality of steam chambers 106 that are merely represented in FIG. 3. Steam chamber 106 is comprised of a plurality of rectangular, structurally-sound and enclosed containers adjoining retainer 104. Retainer 104 appears in this configuration to be as a substantially vertical rectangular structure, while steam chamber 106 is depicted as a substantially horizontal rectangular structure. Those skilled in the art will recognize that a wide variety of other shapes and configurations can be used for the purposes described herein.

Transporter 111, as shown in FIGS. 3 and 4, is located inside each retainer 104 and steam chamber 106 and is driven by a separate power drive assembly (not shown). In one embodiment, the transporter 111 drive assembly is positioned near retainer 104 and is comprised of a one horsepower electric motor which is connected to a small gear box through a system of belt-driven pulleys (not shown). A standard pulley arrangement used in industrial applications of this nature will be recognized by those skilled in the art. Belts or other operating lines for pulley use may be manufactured from other materials such as wire, wire rope, synthetic cord, and other suitable materials so long as the material chosen has the flexibility to work in a pulley system and the strength required to endure extended heavy equipment industrial operations.

Transporter 111 is used to move the oil seeds from retainer 104 to steam chamber 106, and on to chute 108 and may be a conveyor belt or similar conveyance apparatus. To facilitate the movement of the oil seeds along transporter 111 and to help ensure all seeds are treated completely and substantially evenly during the steaming process, a steam chamber shaft 105 is equipped with members 107 positioned to work in tandem with transporter 111. A plurality of rotating members 107 are employed, as shown in FIGS. 3 and 4, and in combination with the movement of transporter 111, ease the movement of oil seeds as they slowly push the oil seeds into chute 108, ensuring that the oil seeds don't move back into steam chamber 106. Further easing of oil seed movement through the steam chamber 106 is obtained when transporter 111 employs a plurality of non-rotating members working along with the rotating members 107 of steam chamber shaft 105. Steam chamber shaft 105 is also driven by a separate power drive assembly (not shown). In one embodiment, the steam chamber shaft 105 drive assembly is positioned near retainer 104 and is comprised of a one horsepower electric motor which is connected to a small gear box through a system of belt-driven pulleys (not shown). The pulleys (not shown) may be of the same system of pulleys used to drive transporter 111. Similarly, a standard pulley arrangement and materials used in industrial applications of this nature will be recognized by those skilled in the art.

Steam chamber 106 is further outfitted with steam producing equipment (not shown) to provide a sufficient steam-filled environment to properly soften the seeds for purposes of crushing. Steam may be produced in a boiler or similar steaming device external to oil extractor 100 and piped to steam chamber 106. Further, nozzles (not shown) can be installed within steam chamber 106 to meter and distribute the steam throughout the steam chamber 106. In another embodiment steam chamber shaft 105 may be outfitted with a plurality of perforations to distribute the steam within the steam chamber 106. Other steam production mechanisms may be employed, and the methods to employ the most suitable means of steam production for a particular application of this invention will be obvious to those skilled in the art.

Referring again to FIG. 4, upon leaving steam chamber 106 the oil seeds enter chute 108. The entire assembly comprising chute 108 is shown in FIG. 3 outlined in phantom. Similarly as with steam chamber 106 described above, a plurality of chutes 108 are merely represented in FIG. 3 and depicted in more detail in FIG. 2.

As shown in FIG. 3, chute 108 is outfitted with a chute drive shaft 103 which is also driven by a separate power drive assembly (not shown). In one embodiment, the chute 108 drive assembly is comprised of a three-quarter horsepower electric motor, positioned on the back side of chute 108, and is connected to a small gear box through a system of belt-driven pulleys (not shown). The purpose of rotating chute 108 is to ease the transfer of the oil seeds entering chute 108 from steam chamber 106 and for metering the oil seeds towards the first end 114 of worm drive 110. A standard pulley arrangement and materials used in industrial applications of this nature will be recognized by those skilled in the art.

Referring also to FIG. 4, the oil seeds exit chute 108 and are metered toward worm drive housing 113 (shown outlined in phantom in FIG. 3) and into worm drive 110. As discussed in more detail above, worm drive 110 can comprise either worm 112 rotating within casing 116, or worm 112 affixed to worm drive shaft 118 which together rotate inside casing 116. Worm drive 110 is mounted onto housing 102. Worm 112, or worm drive shaft 118, is rotatably mounted, facilitated by bearings, on to housing 102. Worm 112 pulls the oil seeds into worm drive housing 113. In the embodiment shown in FIG. 3, rotating worm 112 engages the oil seeds as the oil seeds enter worm drive housing 113 and then on to worm drive 110 from chute 108. Worm 112 simultaneously pulls the oil seeds into worm drive housing 113 as it crushes the oil seeds in worm drive 110.

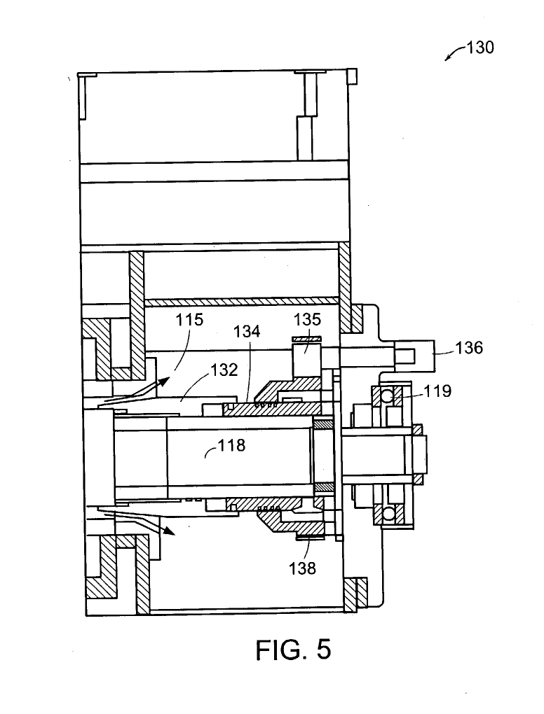

Worm 112 is capable of being fixed or variably pitched. The pitch, defined as the distance in the axial spacing between corresponding points along the spiral worm 112, may decrease as oil seeds travel from the first end 114 of worm drive 110 to the second end 115 of worm drive 110. As the pitch of the worm 112 decreases the compression ratio increases. The increase in the compression ratio increases the crushing pressure on the oil seeds as the oil seeds move along worm 112. The varying quantity of pressure improves the efficiency of the crushing process by effecting a more complete crushing of all of the oil seeds. As the oil seeds begin the crushing process the oil seeds are relatively intact. However, the increasing compression ratio increases the pressure on the relatively intact but unraveling oil seeds and provides additional crushing action to completely extract the desired amount of oil from the oil seeds. As discussed in more detail with FIG. 5 below, the crushing pressure is further modulated using oil seed cake thickness adjuster 130. Also, as noted in more detail below, over-crushing is not desirable. The pitch of the worm drive 110 can also be changed for each operation of the oil extractor 100 by exchanging worms 112 or worm drive shafts 118 when oil extractor 100 is shut down. For cleaning purposes, the spine of each of the worm drive 110 assemblies is specifically designed for easy removal of waste and debris that collects inside worm drive 110.

FIG. 3 shows driver 120 outlined in phantom. In the illustrative embodiment, driver 120 comprises a motor 140 directly coupled with a power transmission assembly 150 to provide motive power to worm drive 110. Direct transmission of power from driver 120 to worm drive 110 reduces transmission losses and reduces accessories. In the preferred embodiment, oil extractor 100 employs a 30 horsepower flange-mounted electric drive motor 140 using transmission through planetary gears 170-185 for crushing approximately 18 tons to 28 tons of oil seeds per day. In one embodiment motor 140 may be replaced with a suitably sized diesel engine, so long as the engine supplies the horsepower required for optimally operating oil extractor 100.

One embodiment of power transmission assembly 150 is comprised of a series of gears and pinions centering about a rotatable planetary gear 170. Power transmission assembly 150 of this embodiment utilizes power in a more efficient manner, in part by driving a plurality of worm assemblies, as compared with simple gear trains and belt-and-pulley systems used to run only one-worm assemblies. In the embodiments illustrated in FIGS. 2 through 4, power transmission assembly 150 is used to run three worm drives 110 at a time using the same output power as for one worm 112 by efficiently distributing the input power. Further, the larger crushing area provided by operating three worm drives 110 simultaneously versus operating only one ensures that the oil percentage in the oil seed cake is consistently maintained at the optimum levels. In one embodiment, the optimum oil percentage level is approximately 6 to 7%. In addition, the illustrative embodiment features a lower operating temperature for oil seed steaming and processing which results in the oil seed cake experiencing little or substantially none of the protein degradation that often occurs when oil seeds are processed at higher heat levels. In one embodiment of the invention, fins disposed on casings 116 providing air circulation for cooling, thereby facilitating reduced operating temperatures.

FIG. 3 shows power transmission assembly 150 in greater detail. The first end 114 of worm drive 110 is connected to power transmission assembly 150. The gear ratio of power transmission assembly 150 is designed to provide oil extractor 100 with the proper speed and torque to optimally operate all internal components upon which those components rely. Further, the proper gear ratio helps minimize excessive vibrations that impart wear-and-tear on the machinery.

As in the present invention, power transmission assembly 150 comprises a rotatable planetary gear 170, a fixed planetary gear 172, a planetary gear wheel 174, a motor coupler gear 176, a planetary pinion 178, a torque divider pinion 180, and a torque divider gear 182. Beginning from the oil extractor 100 housing 102 side and working toward motor 140, worm drive shaft 118 is rotatably coupled with torque divider gear 182. Torque divider gear 182 is rotatably coupled with torque divider pinion 180, which is in turn rotatably coupled with planetary gear wheel 174. Planetary gear wheel 174, mounted on a planetary plate (not shown), is rotatably coupled with planetary pinion 178, which is further rotatably coupled with fixed planetary gear 172. Fixed planetary gear 172 is further rotatably coupled with rotatable planetary gear 170, which is in turn rotatably coupled with motor coupler gear 176, which is directly coupled to the shaft 185 of motor 140.

FIGS. 3 and 4 display three worm drive shafts 118 in operation. The middle worm drive shaft 118 is not shown as it is located on the back side of oil extractor 100 in the figures as presented. A similar torque divider gear 182 is located in a comparable location in oil extractor 100 to couple the middle worm drive shaft 118. In operation, when power from motor 140 is converted into the torque of motor shaft 185, each successive gear and pinion coupling transmits torque from one to the other according to predetermined gear ratios in reverse of the order described above. This torque is ultimately imparted upon worms 112, worm drive shafts 118, and other rotatable equipment previously discussed. Those ordinary skilled in the art would be able to employ comparable driver systems imparting proper specifications to optimally operate oil extractor 100.

FIG. 5 is a cross-sectional view depicting the details of an embodiment of an oil seed cake thickness adjuster 130, constructed according to the invention. Varying the thickness of the oil seed cake is important to maintain the proper crushing pressure of the oil seeds. The amount of crushing pressure is important for a number of reasons. First, the oil seed crushing process depends on the weather conditions prevailing during the season. In the moist, more humid conditions, the crushing pressure requirement is greater. On the other hand, in the drier conditions, the crushing pressure requirement is less. Second, due to nutritional food-related uses of the oil seed cake, excessive crushing pressures lead to the burning of protein, vitamins, and other useful nutrients in the oil seed cake thereby degrading the quality of the oil seed cake. Therefore, to maintain the optimum pressure for crushing in relation to the seasonal factors, as well as to maintain the quality of the cake, varying the thickness of the oil seed cake is required. Significantly, oil seed cake thickness adjuster 130 can be adjusted during operation of oil extractor 100.

In the illustrative embodiment of FIG. 5, oil seed cake thickness adjuster 130 is comprised of a cone 132, a jack 134, a jack gear wheel 138, a jack gear pinion 135, and a jack gear wheel adjusting knob 136. Cone 132 is slidably positioned around worm drive shaft 118 at the worm drive second end 115. In the embodiment of FIG. 5, jack 134 is slidably affixed around worm drive shaft 118 further past the worm drive second end 115. In operation, the jack gear wheel 138 is rotated by manually adjusting jack gear wheel adjusting knob 136. Jack gear wheel adjusting knob 136 rotates jack gear pinion 135, which in turn rotates jack gear wheel 138. Jack gear wheel 138 pushes jack 134 towards the worm drive first end 114, exerting pressure on cone 132. As cone 132 is pushed inward towards worm drive first end 114, the outlet surface area of the oil seed cake decreases. The decreased outlet surface area of the oil seed cake reduces the thickness of the oil seed cake. The increasing pressure on cone 132 resulting in a thinner oil seed cake translates into an increase in back pressure into worm drive 110, and thus additional crushing pressure is exerted on the oil seeds in worm drive 110. Alternatively, when jack 134 is pulled outward toward worm drive second end 115, the thickness of the oil seed cake increases. Conversely, the decreasing pressure on cone 132 resulting in a thicker oil seed cake translates into a decrease in back pressure into worm drive 110, and thus less crushing pressure is exerted on the oil seeds in worm drive 110. Each worm drive shaft 118 is separately equipped with its own oil seed cake thickness adjuster 130. The oil seed cake is collected external to housing 102 once it is extruded.

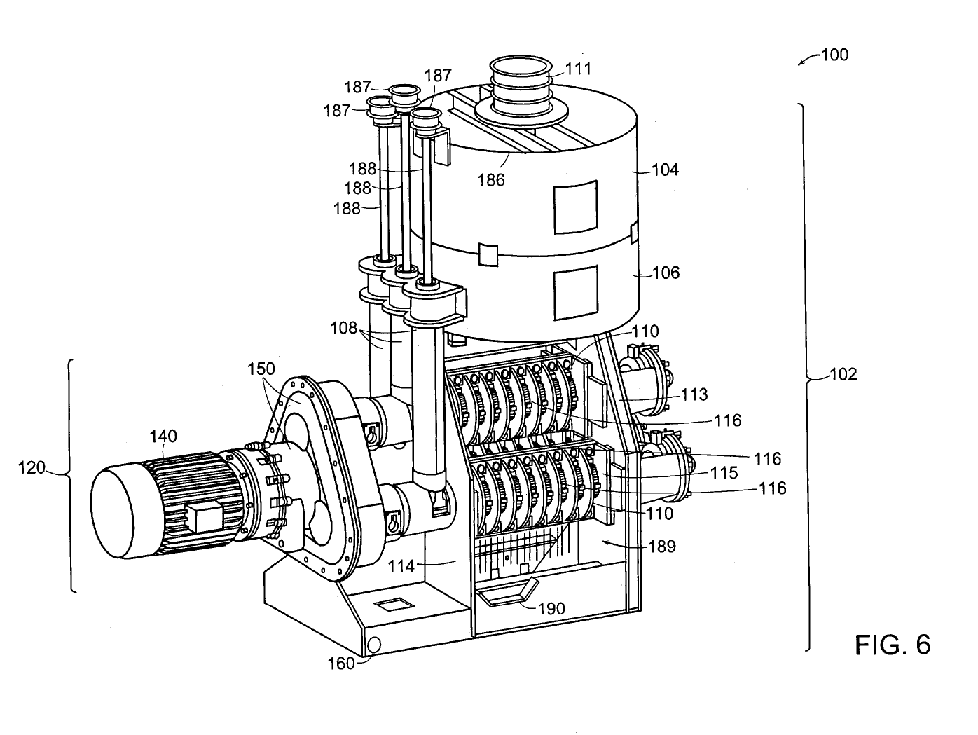

FIG. 6 is a perspective view of another embodiment of an oil extractor, constructed according to the invention. In this embodiment retainer 104 and steam chamber 106 are vertically disposed relative to each other and are positioned at the top of a structurally supportive housing 102. Further, retainer 104 and steam chamber 106 are substantially cylindrical in shape and are constructed of a suitable structural material that is also capable of withstanding the heat generated by steam introduced into steam chamber 106. To maximize the amount of oil extracted from the oil seeds, high processing heats are desirable. In one embodiment, the temperature of the oil seeds are about 90° C. to about 100° C. In one embodiment, retainer 104 and steam chamber 106 are separated by a substantially porous and substantially horizontally disposed barrier (not shown).

Oil seeds are loaded into the top of retainer 104 and are sifted into steam chamber 106 with the assistance of rotating transporter 111 at a rate consistent with the oil seed processing capacity of steam chamber 106. The substantially vertical drive axle 186 of transporter 111 penetrates the substantially horizontal barrier (not shown) which separates retainer 104 from steam chamber 106. Vertical drive axle 186 also rotates within steam chamber 106 to assist the now steamed and softened oil seeds towards chutes 108 which feed the oil seeds into worm drive housing 113. Transporter 111 is positioned inside retainer 104 and steam chamber 106 in a substantially vertical fashion and is driven by driver 120 through a system of belt-driven pulleys (not shown).

In this embodiment, the pulley system (not shown) is located on the driver 120 side of housing 102 and is mounted such that the transporter drive mechanism 187 is positioned above housing 102. The pulley system (not shown) transverses transporter drive mechanism 187 to an upper portion of transporter 111 designed to receive the pulley system (not shown). Power from power transmission assembly 150 is converted from the pulley system (not shown) to transporter 111. A standard pulley arrangement used in industrial applications of this nature will be recognized by those skilled in the art. Belts or other operating lines for pulley use may be manufactured from other materials such as wire, wire rope, synthetic cord, and other suitable materials so long as the material chosen has the flexibility to work in a pulley system and the strength required to endure extended heavy equipment industrial operations.

Referring again to FIG. 6, upon leaving steam chamber 106, the oil seeds enter chutes 108. In this embodiment a plurality of chutes 108 are depicted. Shaft 188 for transporter drive mechanism 187 penetrates chutes 108. The oil seeds exit chutes 108 and are gravity fed toward worm drive housing 113 and into worm drive 110.

Similarly to the embodiment described in more detail for FIGS. 2 and 3, worm drive housing 113 is comprised of worm drives 110 which, when rotated by driver 120, crush the oil seeds using worms (not shown), which rotate inside casings 116 providing the necessary crushing action to the oil seeds. In the embodiment shown, the worm drive casings 116 are substantially porous such that when the oil seeds are crushed by the worms (not shown) the oil 189 extracted from the seeds exits the pores of the casings 116 and, with the aid of gravity, settles in drip pan 190. The oil 189 is then directed into a drain line (not shown) which resides underneath drip pan 190 and directs the oil 189 to drain 160 where the oil 189 is collected. The remnants of the oil seeds are extruded from worm drive housing 113 and collected at the second end 115 of worm drive 110 as an oil seed cake. The embodiment of FIG. 6 may also be outfitted with an oil seed cake thickness adjuster (not shown) to vary the thickness of the oil seed cake as needed.

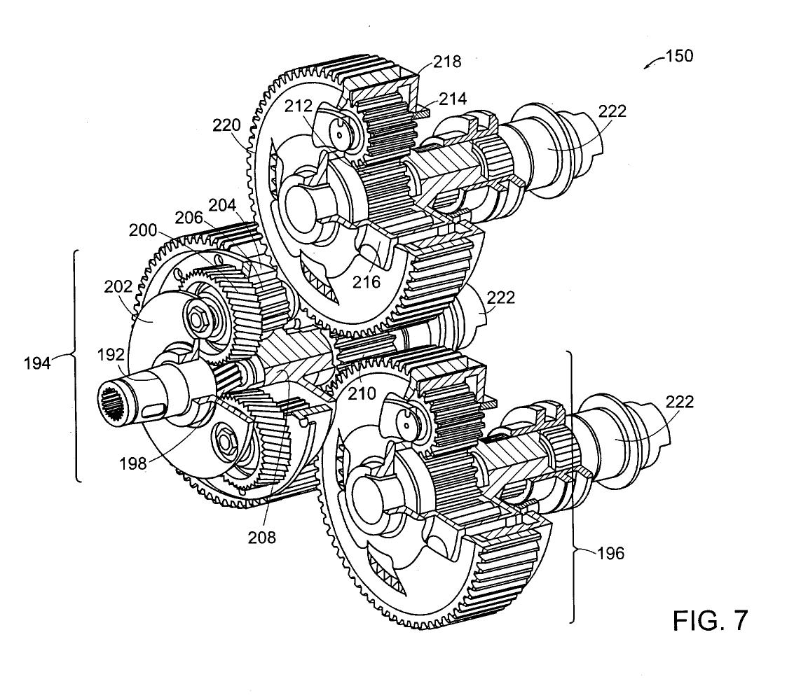

The embodiment of FIG. 6 depicts a preferred embodiment of a power transmission assembly 150 embodiment. FIG. 7 is a perspective view showing greater detail of an embodiment of the power transmission assembly 150 of FIG. 6, constructed according to the invention. This embodiment of power transmission assembly 150 is comprised of two stages of planetary gear assemblies.

Referring also to FIG. 6, the first end 114 of worm drive 110 is connected to power transmission assembly 150. In this illustrative embodiment, power transmission assembly 150 comprises a first stage and a second stage. Power enters power transmission assembly 150 from a second end of motor 140 and is transferred toward power transmission assembly 150 via a first shaft 192. First shaft 192 operates first stage planetary gear assembly 194, which in turn operates a plurality of second stage planetary gear assemblies 196, where one second stage planetary gear assembly operates each worm drive 110.

The first stage planetary gear assembly 194 further comprises a sun gear 198, a plurality of first stage planet gears 200, a first stage planet carrier 202, and a first stage fixed ring gear 204. Power from motor 140 enters power transmission assembly 150 via first shaft 192 causing first stage sun gear 198 to rotate clockwise. In a preferred embodiment, first stage sun gear 198 is a helical-type gear designed to absorb axial and radial loads from motor 140, transferring them to each of a plurality of first stage planet gears 200. First stage planet gears 200 are rotatably coupled to first stage sun gear 198 and are comprised of mating helical-type gears. In a preferred embodiment, the gearing beyond first stage 194 should generate no axial forces when under a torsional load, and therefore straight-teeth-type planet extension gears 206 are coaxially mounted with each first stage planet gear 200 to facilitate a preferred gearing transition. Furthermore, in this preferred embodiment of power transmission assembly 150, straight-teeth-type gears are employed for all remaining gears.

As first stage planet gears 200 rotate in a counterclockwise direction, so do planet extension gears 206, which in turn are rotatably coupled with first stage fixed ring gear 204. First stage planet gears 200 and their respective planet extension gears 206 each rotate in a counterclockwise direction about their own axes. However, by way of their respective couplings to first stage fixed ring gear 204, the entire first stage planet carrier 202, to which planet extension gears 206 are mounted, also rotates, but in a clockwise direction. First stage planet carrier 202 provides the output for the first stage 194 of power transmission assembly 150 by driving a second shaft 208 of power transmission assembly 150. First stage planet carrier 202 is directly coupled to second shaft 208 of power transmission assembly 150. Power is in turn transferred to the second stage 196 of power transmission assembly 150 through transfer pinion gear 210 which is axially mounted to second shaft 208. In a preferred embodiment of the invention, and depending upon the gear ratios employed, second shaft 208 can rotate at a substantially slower speed than that of first shaft 192.

Second stage 196 planetary gear assembly is comprised of a plurality of planetary gear assemblies that are each further comprised of a second stage sun gear 212, a plurality of second stage planet gears 214, a second stage planet carrier 216, and a second stage fixed ring gear 218. Each second stage 196 planetary gear assembly is encased by a transfer wheel gear 220. In a preferred embodiment, transfer wheel gear 220 is rotatably coupled to transfer pinion gear 210, thereby rotating each of the plurality of second stage 196 planetary gear assemblies in a counterclockwise direction. Each of the plurality of second stage 196 planetary gear assemblies may be viewed as its own planetary gear which rotates about transfer pinion gear 210. Transfer pinion gear 210 in effect serves as a sun gear for the entire second stage 196, and is rotatably coupled to each of these “planetary gears” by way of transfer wheel gear 220.

In a preferred embodiment, each transfer wheel gear 220 is directly coupled to its respective second stage planet carrier 216, thereby resulting in a counterclockwise rotation of each second stage planet carrier 216. Within each of the plurality of second stage planet carriers 216, each of a plurality of second stage planet gears 214 is rotated about its respective axis in a clockwise direction. This rotation of each second stage planet gear 214 is a result of the rotation of each second stage planet carrier 216 within each second stage 196 planetary gear assembly, and each respective second stage planet gear 214 meshing with each second stage fixed ring gear 218. A plurality of second stage planet gears 214 within each second stage 196 planetary gear assembly are rotatably coupled with each second stage sun gear 212, causing each second stage sun gear 212 to rotate in a counterclockwise direction. The rotation of each second stage sun gear 212 results in the counterclockwise rotation of one of a plurality of third shafts 222 which in turn operate a respective worm drive 110. In a preferred embodiment of the invention, and depending upon the gear ratios employed, third shaft 222 can rotate at a substantially faster speed than that of second shaft 208.

The planetary gear assembly of the illustrative embodiment allows for a single motor 140 to equally distribute its output power among a plurality of worm drives 110 and may afford numerous gear ratio combinations. The variety of gear ratio combinations may facilitate changes in speed and reversal of direction, and provides for the optimum gear ratios for most efficiently crushing the oil seeds being processed at any given time. This arrangement is energy efficient in providing such refined optimizations, and it facilitates noise, vibration, and friction loss reduction.

In operation, when power from motor 140 is converted into the torque of motor shaft 185, each successive gear and pinion coupling transmits torque from one to the other according to predetermined gear ratios in the manner described above. This torque is ultimately imparted upon worms 112, worm drive shafts 118, and other rotatable equipment previously discussed, including those utilizing a pulley system. Those ordinary skilled in the art would be able to employ comparable driver systems imparting proper specifications to optimally operate oil extractor 100.

While the invention has been shown and described with reference to specific preferred embodiments, it should be understood by those skilled in the art that various changes in form and detail may be made therein without departing from the spirit and scope of the invention as defined by the following claims.

What is claimed is:

1. An oil extractor comprising:
a steam chamber;
a worm drive housing in communication with said steam chamber;
a worm drive contained within said worm drive housing, each worm drive having a first end and a second end; and
a driver in communication with said worm drive.

2. An oil extractor comprising:
a worm drive housing;
a worm drive contained within said worm drive housing, each worm drive having a first end and a second end;
a driver in communication with said worm drive; and
an oil seed cake thickness adjuster in communication with said second end of said worm drive, wherein the thickness of the oil seed cake is adjusted during operation.

3. The oil extractor of claim 2, wherein said oil seed cake thickness adjuster comprises:
a cone having a first end and a second end surrounding said worm drive at said worm drive second end; and
a jack located at said second end of said cone, said jack displacing said cone to a clearance that facilitates a desired thickness for the oil seed cake.

4. An oil extractor comprising:
a steam chamber;
a worm drive housing in communication with said steam chamber;
a worm drive contained within said worm drive housing, said worm drive having a first end and a second end;
a driver in communication with said worm drive; and
an oil seed cake thickness adjuster in communication with said second end of said worm drive, said oil seed cake thickness adjuster adjusting the thickness of the oil seed cake during operation.

5. The oil extractor of claim 4, further comprising a retainer in communication with said steam chamber, said retainer retaining oil seeds before they enter said steam chamber.

6. The oil extractor of claim 5, wherein said retainer comprises a transporter.

7. The oil extractor of claim 4, wherein said steam chamber comprises a transporter.

8. The oil extractor of claim 7, wherein said transporter further comprises a plurality of members, wherein said members assist oil seeds along said transporter and through said steam chamber.

9. The oil extractor of claim 7, wherein said steam chamber includes a steam chamber shaft.

10. The oil extractor of claim 9, wherein said steam chamber shaft further comprises a plurality of members, wherein said members assist oil seeds along said transporter and through said steam chamber.

11. The oil extractor of claim 4, wherein the pitch of said worm drive is variable from said first end to said second end.

12. The oil extractor of claim 4, wherein the pitch of said worm drive decreases from said first end to said second end of said worm drive.

13. The oil extractor of claim 4, wherein the pitch of said worm drive can be changed for each operation of said oil extractor.

14. The oil extractor of claim 4, wherein said driver is a power transmission driver.

15. The oil extractor of claim 14, wherein said power transmission driver is comprised of a planetary gear assembly.

16. The oil extractor of claim 4, further comprising a rotatably mounted chute located between said steam chamber and said worm drive, wherein said rotatably mounted chute facilitates movement of oil seeds to said worm drive.

17. An oil extractor comprising:
a means for steaming oil seeds;
a means for crushing the oil seeds, said means in communication with said means for steaming oils seeds; and
a means for adjusting the thickness of an oil seed cake, said means in communication with said means for crushing oil seeds.

18. A method for extracting oil from oil seeds comprising:
providing a plurality of oil seeds;
crushing the oil seeds into an oil seed cake; and
varying the thickness of the oil seed cake during oil expelling.

19. The method of claim 18, further comprising:
steaming said plurality of oil seeds prior to crushing.

20. A power transmission assembly comprising:
a first stage planetary gear assembly further comprising
a first shaft;
a sun gear coaxially disposed upon said first shaft;
a plurality of first stage planet gears rotatably coupled with said sun gear;
a first stage fixed ring gear rotatably coupled with said first stage planet gears;
a first stage planet carrier directly coupled with said first stage planet gears;
a second shaft positioned coaxially opposite said first shaft and directly coupled to said first stage planet carrier;
a transfer pinion gear directly coupled to said second shaft; and
a plurality of second stage planetary gear assemblies rotatably coupled about said transfer pinion gear, each second stage planetary gear assembly further comprising:
a transfer wheel gear rotatably coupled with said transfer pinion gear;
a second stage planet carrier directly coupled with said transfer wheel gear;
a plurality of second stage planet gears directly coupled to said second stage planet carrier;
a second stage fixed ring gear rotatably coupled with said second stage planet gears;
a second stage sun gear rotatably coupled with said second stage planet gears; and
a third shaft coaxially disposed with said second stage sun gear,
whereby each of a plurality of said third shafts drives a load.

21. An oil extractor comprising:
a retainer;
a steam chamber in vertical communication with said retainer;
a worm drive housing in communication with said steam chamber;
a worm drive contained within said worm drive housing, said worm drive having a first end and a second end;
a driver in communication with said worm drive; and
an oil seed cake thickness adjuster in communication with said second end of said worm drive, said oil seed cake thickness adjuster adjusting the thickness of the oil seed cake during operation, wherein the oil seed cake produced has substantially no protein degradation due to heat.

22. The oil extractor of claim 21 wherein the oil seed cake produced has less protein degradation caused by heat than that due to standard means of producing oil seed cake.
